(19) United States
(12) Patent Application Publication
(10) Pub. No.: US 2026/0116205 A1
(43) Pub. Date: Apr. 30, 2026

(54) SYSTEM AND METHOD FOR GUIDING REGENERATIVE BRAKING USE OF VEHICLE

(71) Applicants: Hyundai Motor Company, Seoul (KR); Kia Corporation, Seoul (KR)

(72) Inventor: Wook Hyun Han, Hwaseong-si (KR)

(73) Assignees: Hyundai Motor Company, Seoul (KR); Kia Corporation, Seoul (KR)

(21) Appl. No.: 19/247,584

(22) Filed: Jun. 24, 2025

(30) Foreign Application Priority Data
Oct. 25, 2024 (KR) 10-2024-0147436

(51) Int. Cl. B60L 7/18; B60L 3/12; B60Q 9/00

(52) U.S. Cl. CPC B60L 7/18; B60L 3/12; B60Q 9/00; B60L 2240/16; B60L 2240/642; B60L 2250/26

(57) ABSTRACT

A system for guiding regenerative braking use of a vehicle includes a controller configured to transmit driving data in the vehicle, an input/output unit connected to the controller of the vehicle, and a central server selecting a driver who uses regenerative braking less than a predetermined amount of use by collecting the driving data transmitted from the controller of the vehicle, wherein the central server determines a maximum possible regenerative braking ratio and an actual regenerative braking ratio of the vehicle, a driver who uses regenerative braking less than a predetermined amount of use, and requests the vehicle of the selected driver who uses regenerative braking less than a predetermined amount of use to output a message recommending an increase of use of regenerative braking, and the controller of the vehicle controls an input/output unit to output the message in accordance with the request for outputting the message.

### CROSS REFERENCE TO RELATED APPLICATION

The present application claims priority to Korean Patent Application No. 10-2024-0147436, filed on Oct. 25, 2024, the entire contents of which is incorporated herein for all purposes by this reference.

### BACKGROUND OF THE PRESENT DISCLOSURE

### Field of the Present Disclosure

The present disclosure relates to a system and method for guiding regenerative braking use of a vehicle, the system and method capable of objectively and quantitatively distinguishing and determining drivers with insufficient regenerative braking usage based on vehicle's driving data and capable of recommending and encouraging use of regenerative braking for the drivers who are determined to have insufficient generative braking usage.

### Description of Related Art

The biggest advantage that eco-friendly vehicles, such as electric vehicles, hybrid vehicles, and fuel cell vehicles, that are driven by a motor have over internal combustion engine vehicles is the ability to recover wasted energy through regenerative braking by a motor.

However, among drivers of eco-friendly vehicles, there are many cases where they do not use regenerative braking because they do not fully recognize the energy efficiency improvement or maintenance cost reduction effects provided by regenerative braking.

If drivers with insufficient use of regenerative braking are allowed to experience an effect of energy efficiency improvement or reduction in maintenance costs of braking-related consumables when using regenerative braking, it will yield positive effects not only for the drivers but also for the vehicle manufacturers.

Considering this, in the current situation where the production and use of eco-friendly vehicles are increasing, it is required to apply a technology, which encourages and guides use of regenerative braking for drivers with insufficient regenerative braking usage, to eco-friendly vehicles.

However, to the present end, it is required to accurately distinguish drivers with insufficient regenerative braking usage, and the regenerative braking usage may vary, depending on the driving paths of vehicles, or the exterior design or powertrain characteristics of vehicles. For example, drivers who primarily drive on city roads have more braking zones, so they use regenerative braking more frequently than drivers who drive only on highways.

Accordingly, when only the regenerative braking usage is compared to distinguish drivers with insufficient regenerative braking usage, drivers who primarily drive on highways may be mistakenly judged as drivers with insufficient use of regenerative braking even though they try to maximally use regenerative braking in consideration of their driving routes.

Accordingly, there is a demand for a method of more objectively and accurately determining and selecting users with insufficient use of regenerative braking and a method of actively encouraging use of regenerative braking for selected drivers with insufficient use regenerative braking.

In the case of commercial vehicle, use of regenerative braking is almost nonexistent and traditional braking methods such as friction braking are mainly used due to excessive weight and rough driving routes, so durability problems of braking-related consumables or issues due to overheating of the braking system occur frequently.

Accordingly, there is a demand for a method that can more objectively and quantitatively distinguish and select drivers with insufficient use of regenerative braking based on driving data and can actively recommend and encourage use of regenerative braking.

The information included in this Background of the present disclosure is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing a system and method for guiding regenerative braking use of a vehicle, the system and method configured for objectively and quantitatively distinguishing and determining drivers with insufficient regenerative braking usage based on vehicle's driving data and configured for recommending and encouraging use of regenerative braking for the drivers who are determined to have insufficient regenerative braking usage.

The objectives of the present disclosure are not limited to those described above and other objectives not stated herein would be apparently understood by those who have ordinary skills in the art that the present disclosure belongs to (hereafter, “those skilled in the art”) from the following description.

To achieve the objectives described above, a system for guiding regenerative braking use of a vehicle according to an exemplary embodiment of the present disclosure includes: a controller configured to transmit driving data through a communication unit operatively connected to the controller in the vehicle; an input/output unit connected to the controller of the vehicle, and a central server selecting a driver who uses regenerative braking less than a predetermined amount of use by collecting the driving data transmitted from the controller of the vehicle, wherein the central server is configured to determine a maximum possible regenerative braking ratio and an actual regenerative braking ratio of the vehicle based on the collected driving data of the vehicle, selects the driver who uses regenerative braking less than a predetermined amount of use using the determined maximum possible regenerative braking ratio and the determined actual regenerative braking ratio, and requests the vehicle of the selected driver who uses regenerative braking less than a predetermined amount of use to output a message recommending an increase of use of regenerative braking, and the controller of the vehicle is configured to control the input/output unit to output the message in accordance with the request for outputting the message received from the central server.

In the present configuration, the central server may collect driving data transmitted from a plurality of vehicles and may select drivers with insufficient use of regenerative braking among drivers of the vehicles using a maximum possible regenerative braking ratio and an actual regenerative braking ratio of each of the vehicles based on the collected driving data of the vehicles.

Furthermore, the controller may select a regenerative braking map with larger regenerative braking torque when the driver selects the increase of use of the regenerative braking through the input/output unit with the message output by the input/output unit, and may be configured for controlling regenerative operation of a motor that drives the vehicle based on the larger regenerative braking torque determined by the selected regenerative braking map.

Furthermore, a plurality of regenerative braking maps set for regenerative braking stages, respectively, may be stored in the controller, and the plurality of regenerative braking maps may be maps in which regenerative braking torque according to a vehicle speed is set, and may be maps in which regenerative braking torque is differently set at a same vehicle speed.

Furthermore, the driving data may include: driving energy information of the vehicle which is determined based on information set in the vehicle and information collected while driving; and operation information of a motor that drives the vehicle.

Furthermore, the driving energy information of the vehicle may include gradient energy in uphill driving, acceleration energy, and diving resistance consumption energy in each of an accelerator pedal operation period and an accelerator pedal non-operation period that are determined by equations based on the set information and the information collected while driving.

Furthermore, the central server may be configured to determine wheel-based acceleration energy using the diving resistance consumption energy in the accelerator pedal operation period and the gradient energy in the uphill driving, may be configured to determine wheel-based recoverable maximum regenerative braking energy from the wheel-based acceleration energy and the diving resistance consumption energy in the accelerator pedal non-operation period, and may be configured to determine the maximum possible regenerative braking ratio using the determined wheel-based recoverable maximum regenerative braking energy.

Furthermore, the central server may be configured to determine the wheel-based recoverable maximum regenerative braking energy as a value obtained by subtracting the diving resistance consumption energy in the accelerator pedal non-operation period from a sum of the wheel-based acceleration energy and the gradient energy in the uphill driving.

In the present configuration, the central server may be configured to determine the maximum possible regenerative braking ratio as a ratio value obtained by dividing the wheel-based recoverable maximum regenerative braking energy by a sum of the wheel-based acceleration energy, the gradient energy in the uphill driving, and the diving resistance consumption energy in the accelerator pedal operation period.

Furthermore, the central server may be configured to determine wheel-based acceleration energy using the diving resistance consumption energy in the accelerator pedal operation period and the gradient energy in the uphill driving, and may be configured to determine the actual regenerative braking ratio from a regenerative current which is generated in regenerative braking, a motor voltage in regenerative braking, the wheel-based acceleration energy, the gradient energy in the uphill driving, the diving resistance consumption energy in the accelerator pedal operation period as the operation information of the motor.

Furthermore, the central server may be configured to determine the actual regenerative braking ratio as a ratio value obtained by dividing a product of the regenerative current and the motor voltage by a sum of the wheel-based acceleration energy, the gradient energy in the uphill driving, and the diving resistance consumption energy in the accelerator pedal operation period.

Furthermore, the central server may select a driver who uses regenerative braking less than a predetermined amount of use using a value obtained by dividing the maximum possible regenerative braking ratio of the vehicle by the actual regenerative braking ratio. The central server may be configured to determine a maximum possible regenerative braking ratio and an actual regenerative braking ratio of each of vehicles based on driving data collected for the vehicles, and may select a driver who uses regenerative braking less than a predetermined amount of use using information of average and standard deviation of a percentage value of the actual regenerative braking ratio of each of the vehicles to the maximum possible regenerative braking ratio of each of the vehicles.

Furthermore, a method of guiding regenerative braking use of a vehicle according to an exemplary embodiment of the present disclosure includes: collecting driving data which is transmitted from a vehicle by a central server; determining a maximum possible regenerative braking ratio and an actual regenerative braking ratio of the vehicle based on the collected traveling data of the vehicle by the central server; selecting a driver who uses regenerative braking less than a predetermined amount of use using the determined maximum possible regenerative braking ratio and the determined actual regenerative braking ratio by the central server; requesting the vehicle of the selected driver who uses regenerative braking less than a predetermined amount of use to output a message recommending an increase of use of regenerative braking by the central server; and controlling an input/output unit to output the message by a controller in accordance with the request for outputting the message received from the central server in the vehicle of the selected driver who uses regenerative braking less than a predetermined amount of use.

In the instant case, the controller may select a regenerative braking map with larger regenerative braking torque when the driver selects the increase of use of the regenerative braking through the input/output unit with the message output by the input/output unit, and may be configured for controlling regenerative operation of a motor that drives the vehicle based on the larger regenerative braking torque determined by the selected regenerative braking map.

Furthermore, the driving data may include: driving energy information of the vehicle which is determined based on information set in the vehicle and information collected while driving; and operation information of a motor that drives the vehicle.

Furthermore, the driving energy information of the vehicle may include gradient energy in uphill driving, acceleration energy, and diving resistance consumption energy in each of an accelerator pedal operation period and an accelerator pedal non-operation period that are determined by equations based on the set information and the information collected while driving.

Furthermore, the determining of the maximum possible regenerative braking ratio of the vehicle may include: determining wheel-based acceleration energy using the diving resistance consumption energy in the accelerator pedal operation period and the gradient energy in the uphill driving; determining wheel-based recoverable maximum regenerative braking energy from the wheel-based acceleration energy and the diving resistance consumption energy in the accelerator pedal non-operation period; and determining the maximum possible regenerative braking ratio using the determined wheel-based recoverable maximum regenerative braking energy.

Furthermore, the determining of an actual regenerative braking ratio may include: determining wheel-based acceleration energy using the diving resistance consumption energy in the accelerator pedal operation period and the gradient energy in the uphill driving; and determining the actual regenerative braking ratio from a regenerative current which is generated in regenerative braking, a motor voltage in regenerative braking, the wheel-based acceleration energy, the gradient energy in the uphill driving, the diving resistance consumption energy in the accelerator pedal operation period as the operation information of the motor.

Furthermore, the selecting of a driver who uses regenerative braking less than a predetermined amount of use may select a driver who uses regenerative braking less than a predetermined amount of use using a value obtained by dividing the maximum possible regenerative braking ratio of the vehicle by the actual regenerative braking ratio.

Therefore, according to the system and method for guiding regenerative braking use of a vehicle of the present disclosure, it is possible to more objectively and quantitatively distinguish users with insufficient use of regenerative braking by comparing actual recovery energy to recoverable maximum braking energy reflecting the driving route and vehicle characteristics of each of drivers through driving energy.

Furthermore, it is possible to encourage drivers determined as using regenerative braking lower than the average level to actively use regenerative braking by guiding the effects when using regenerative braking at the level of average.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

FIG. 1 is a block diagram showing the configuration of a system that performs a regenerative braking use guidance process of a vehicle according to an exemplary embodiment of the present disclosure;

FIG. 2 is a flowchart showing the regenerative braking use guidance process according to an exemplary embodiment of the present disclosure;

FIG. 3 is a schematic diagram showing transmission of driving data of a plurality of vehicles from the vehicles to a central server in an exemplary embodiment of the present disclosure;

FIG. 4 is a diagram illustrating a method of determining a maximum possible regenerative braking ratio in an exemplary embodiment of the present disclosure;

FIG. 5 is a diagram illustrating a method of determining an actual possible regenerative braking ratio in an exemplary embodiment of the present disclosure;

FIG. 6 is a diagram exemplifying a maximum possible regenerative braking ratio and an actual possible regenerative braking ratio of each of vehicles in an exemplary embodiment of the present disclosure;

FIG. 7 is a diagram illustrating a method of selecting drivers insufficient use of regenerative braking using average and standard deviation in an exemplary embodiment of the present disclosure; and

FIG. 8 is a diagram showing an example of a stage-specific regenerative braking map which may be used in a vehicle to which the present disclosure is applied.

It may be understood that the appended drawings are not necessarily to scale, presenting a somewhat simplified representation of various features illustrative of the basic principles of the present disclosure. The specific design features of the present disclosure as included herein, including, for example, specific dimensions, orientations, locations, and shapes will be determined in part by the particularly intended application and use environment.

In the figures, reference numbers refer to the same or equivalent parts of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

Embodiments of the present disclosure will be described hereafter in detail with reference to the accompanying drawings. Description of specific structures and functions included in embodiments of the present disclosure is only an example for describing the exemplary embodiments according to the concept of the present disclosure and the exemplary embodiments according to the concept of the present disclosure may be implemented in various ways. The present disclosure is not limited to the exemplary embodiments described herein and should be construed as including all changes, equivalents, and replacements that are included in the spirit and the range of the present disclosure.

It will be understood that although the terms first and/or second, etc. may be used herein to describe various components, these elements should not be limited by these terms. These terms are used only to distinguish one element from another element. For instance, a first element discussed below could be termed a second element without departing from the right range of the present disclosure. Similarly, the second element could also be termed the first element.

It is to be understood that when one element is referred to as being “connected to” or “coupled to” another element, it may be connected directly to or coupled directly to another element or be connected to or coupled to another element, having the other element intervening therebetween. On the other hand, it is to be understood that when one element is referred to as being “connected directly to” or “coupled directly to” another element, it may be connected to or coupled to another element without the other element intervening therebetween. Furthermore, the terms used herein to describe a relationship between elements, that is, “between”, “directly between”, “adjacent”, or “directly adjacent” should be interpreted in the same manner as those described above.

Like reference numerals indicate the same components throughout the specification. The terms used herein are provided to describe embodiments without limiting the present disclosure. In the specification, a singular form includes a plural form unless specifically stated in the sentences. The terms “comprise” and/or “including” used herein do not exclude that another component, step, operation, and/or element exist or are added in the stated component, step, operation, and/or element.

The present disclosure relates to a system and method for guiding regenerative braking use of vehicle and aims to provide a system and a method that can objectively and quantitatively distinguish and determine drivers with insufficient regenerative braking usage based on vehicle's driving data and then configured for recommending and encouraging use of regenerative braking for the drivers who are determined to have insufficient generative braking usage.

The drivers with insufficient regenerative braking usage is a driver who uses regenerative braking less than a predetermined amount of use.

To this end, in an exemplary embodiment of the present disclosure, a central server collects driving data from the vehicles, determines a maximum possible regenerative braking ratio and an actual regenerative braking ratio of each of the vehicles based on the collected driving data, selects drivers with insufficient use of regenerative braking from the drivers by comparing the determined maximum possible regenerative braking ratio and actual regenerative braking ratio of each of the vehicles, and recommends the selected drivers with insufficient use of regenerative braking to increase regenerative braking use.

Hereafter, a system and method for guiding regenerative braking use of a vehicle according to an exemplary embodiment of the present disclosure is described in more detail.

The present disclosure is useful when applied to commercial vehicles such as buses. Furthermore, the present disclosure may be applicable to vehicles that are provided with a motor as a drive source for driving the vehicle and a drive device for driving the vehicle and can perform regenerative braking using the motor, and for example, it may be applied to electric vehicles and fuel-cell vehicles.

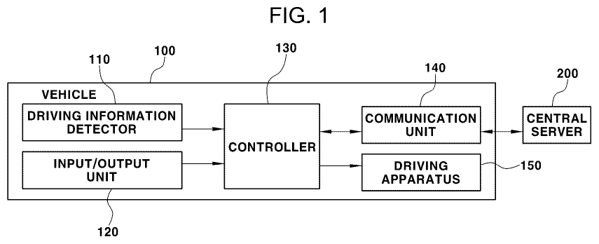

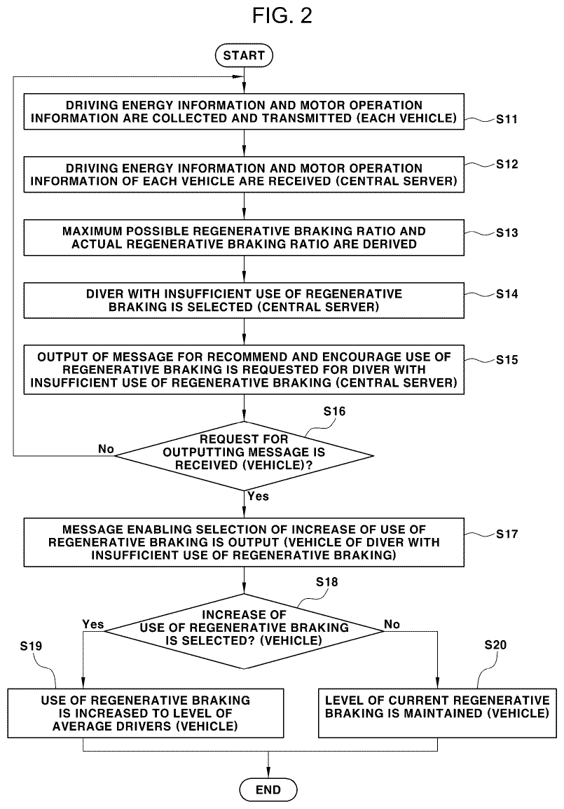

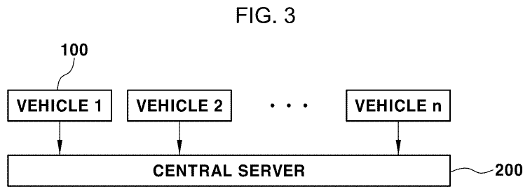

FIG. 1 is a block diagram showing the configuration of a system that is configured to perform a regenerative braking use guidance process of a vehicle according to an exemplary embodiment of the present disclosure and FIG. 2 is a flowchart showing the regenerative braking use guidance process according to an exemplary embodiment of the present disclosure. Furthermore, FIG. 3 is a schematic diagram showing transmission of driving data of a plurality of (n) vehicles from the vehicles to a central server in an exemplary embodiment of the present disclosure.

As shown in FIG. 1, a system that is configured to perform regenerative braking use guidance process includes a driving information detector 110, an input/output unit 120, a controller 130, and a communication unit 140 that disposed in a vehicle 100.

The driving information detector 110 is for detecting information that represents the driving state of the vehicle, that is, vehicle driving information, and may include a vehicle speed detector which is configured to detect a vehicle speed, an acceleration detector which is configured to detect acceleration of the vehicle, and an accelerator pedal detector which is configured to detect an accelerator pedal input value by a driver.

The vehicle speed detector may be a common wheel speed sensor which is configured to detect a wheel speed and it has been generally known in the art that vehicle speed information may be obtained from a signal from a wheel speed sensor, so this is not described in detail.

The acceleration detector may be a common longitudinal acceleration sensor (G sensor) which is configured to detect longitudinal acceleration of a vehicle and the accelerator pedal detector may be a common accelerator position sensor (APS) which is provided on an accelerator pedal and outputs an electrical signal when the accelerator pedal is operated by a driver.

Accordingly, vehicle driving information may include a vehicle speed detected by the vehicle speed detector, vehicle longitudinal acceleration detected by the acceleration detector, and an accelerator pedal input value (APA value, %) detected by the accelerator pedal detector. In an exemplary embodiment of the present disclosure, vehicle longitudinal acceleration may be used to obtain the gradient information of the road the vehicle 100 travels on.

Furthermore, the driving information detector 110 may further include a motor speed detector which is configured to detect a motor rotation speed and the motor speed detector may be a common resolver which is mounted on a motor. As will be described below, when a motor rotation speed is used to determine a powertrain efficiency value, the vehicle driving information may further include a motor rotation speed which is detected by the motor speed detector.

The input/output unit 120 may include an input device provided to enable input of various pieces of information for the regenerative braking use guidance process in an exemplary embodiment of the present disclosure and a display device that displays various pieces of display information and generated information for the regenerative braking use guidance process.

The communication unit 140, which is provided to enable the vehicle 100 to communicate with external systems, is connected to the controller 130, so that the controller 130 of the vehicle 100 is connected to be able to transmit and receive various pieces of information to or from a central server 200 which is an external system through the communication unit 140.

The controller 130 is configured to control the operation of a driving apparatus 150 driving the vehicle 100, and in the instant case, the driving apparatus 150 may be a motor. The motor generates and outputs driving power for driving the vehicle 100 and is configured to perform energy regeneration that recovers the kinetic energy of a vehicle into electrical energy by operating as generator in braking or coasting of the vehicle.

The system that is configured to perform the regenerative braking use guidance process according to an exemplary embodiment of the present disclosure further includes a central server 200 provided outside the vehicle 100 and the central server 200 collects driving data from a plurality of vehicles 100 that exceeds a set mileage (e.g., 1000 km).

In the instant case, the vehicles 100 each transmit driving data to the central server 200 through the communication unit 140 (see step S11 in FIG. 2) and the driving data includes driving energy information and motor operation information.

Furthermore, the driving energy information which is transmitted to the central server 200 from each of the vehicles 100 includes air resistance consumption energy and rolling resistance consumption energy in an accelerator pedal operation period and an accelerator pedal non-operation period, gradient energy in uphill driving, and acceleration energy.

The driving energy information is determined in each of the vehicles 100 from real-time collected information including vehicle driving information detected by the driving information detector 110 and various pieces of preset information, using a predetermined equation.

In an exemplary embodiment of the present disclosure, the motor operation information includes a regenerative current and a motor voltage that are generated during motor regeneration operation of the vehicles 100, and is used for the central server 200 to determine an actual regenerative braking ratio (%) of the vehicles 100.

Accordingly, each of the vehicles 100 transmits the driving energy information and the motor operation information to the central server 200 through the communication unit 140, and the central server 200 can determine a maximum possible regenerative braking ratio (%) and an actual regenerative braking ratio (%) of each of the vehicles based on the driving energy information and the motor operation information received from each of the vehicles 100 (see steps S12 and S13 in FIG. 2).

In general, driving energy, which is the energy consumed when a vehicle is driven for a certain time, may be determined as the sum of the energy consumed by air resistance (hereafter, referred to as “air resistance consumption energy”), the energy consumed by rolling resistance (hereafter, referred to as “rolling resistance consumption energy”), the energy consumed by gradient resistance (hereafter, referred to as “gradient resistance consumption energy”), acceleration energy, regenerative energy, and accessory consumption energy.

The following Equation 1 shows the consumed power when a vehicle is driven, and the consumed power may be obtained from power consumed by driving resistance, power consumed by gradient resistance, acceleration power, regenerative power, accessory consumption power, and the vehicle speed and powertrain efficiency.

The accessory consumption power may be determined as the sum of air-conditioning consumption power, cooling consumption power which is consumed to cool parts or devices, electric part consumption power (Low voltage DC-DC Converter (LDC) consumption power), etc.

The driving energy may be determined by accumulating the consumed power determined using the following Equation 1 for a driving time. That is, driving energy may be determined by integrating the following Equation 1 over time.

$$Power \times ε = [ \frac{1}{2} ( {C}_{d} \cdot ρ \cdot A \cdot {V}^{2} ) + W \cdot cos θ ( RRC + VRC \cdot V ) + W \cdot sin θ + \frac{W}{g} \cdot acc - \frac{W}{g} \cdot dec ] \times V + Aux \qquad [ Equation 1 ]$$

In Equation 1, Power is the consumed power, C_{d} is the drag coefficient of a vehicle, ρ is air density, A is the drag area of a vehicle, V is a vehicle speed, W is vehicle weight, θ is the slope angle of a driving road, RRC is rolling resistance, VRC is viscous resistance, g is gravitational acceleration, acc is vehicle acceleration, dcc is vehicle deceleration, & is powertrain efficiency, and Aux is accessory consumption power including air-conditioning consumption power, cooling consumption power, and electric part consumption power.

In Equation 1,

$$\frac{1}{2} ( {C}_{d} \cdot ρ \cdot A \cdot {V}^{2} )$$

represents power consumed by air resistance (air resistance consumption power) and W·cos θ(RRC+VRC·V) represents power consumed by rolling resistance (rolling resistance consumption power). Furthermore, W·sin θ represents power consumed by gradient resistance (gradient resistance consumption power),

$$\frac{W}{g} \cdot acc$$

represents acceleration power, and

$$\frac{W}{g} \cdot dec$$

represents regenerative power.

In Equation 1, the sum of the air resistance and the rolling resistance is driving resistance and

$$\frac{1}{2} ( {C}_{d} \cdot ρ \cdot A \cdot {V}^{2} ) + W \cdot cos θ ( RRC + VRC \cdot V )$$

which is the sum of the power consumed by air resistance and the power consumed by rolling resistance is driving power P_{drive}.

That is,

$${P}_{drive} = \frac{1}{2} ( {C}_{d} \cdot ρ \cdot A \cdot {V}^{2} ) + W \cdot cos θ ( RRC + VRC \cdot V ) ,$$

### and in Equation 1,

$$\frac{1}{2} ( {C}_{d} \cdot ρ \cdot A \cdot {V}^{2} ) + W \cdot cos θ ( RRC + VRC \cdot V ) + W \cdot sin θ + \frac{W}{g} \cdot acc$$

represents motor driving power. The result of integrating the motor driving power over time is motor driving energy.

The vehicle speed V is real-time detected information which is detected by the vehicle speed detector and the gradient angle θ may be obtained from real-time longitudinal acceleration information of a vehicle which is detected by the acceleration detector (longitudinal acceleration sensor).

The method of determining a gradient angle (slope angle, θ) of a road on which a vehicle travels based on a longitudinal acceleration value has been generally known to those skilled in the art, so it is not described in detail in the specification.

Vehicle weight may be weight set in advance or vehicle weight which is estimated from the longitudinal acceleration value of the vehicle detected by the acceleration detector. The method of estimating vehicle weight based on a longitudinal acceleration value has also been generally known to those skilled in the art, so it is not described in detail in the specification.

The vehicle acceleration acc and the vehicle deceleration dcc may be detected by the acceleration detector (longitudinal acceleration sensor) and the electric part consumption power may be Low voltage DC-DC Converter (LDC) consumption power.

The LDC is a DC-DC converter that converts and supplies the power of a high-voltage battery (main battery) to the low-voltage electric parts in a vehicle and the LDC consumption power is power which is consumed by low-voltage electric parts through the LDC. It has been generally known that LDC consumption power is determined in real time in general vehicles.

The drag coefficient C_{d} which is used to determine air resistance, power consumed by the air resistance, and driving power including the power consumed by the air resistance is also called an air resistance coefficient, which is a vehicle's inherent characteristic value.

The drag area A is a vehicle frontal projected area, which is also a vehicle's inherent characteristic value. The drag coefficient C_{d} and the drag area A that are vehicle's inherent characteristic values may be preset values.

The powertrain efficiency ε is the product of decelerator efficiency and motor efficiency, in which the motor efficiency is the motor driving efficiency when the motor is driven, and is a motor regenerative efficiency in regeneration of the motor.

The motor driving efficiency and the motor regenerative efficiency both may be obtained from the input voltage and input current of the motor, motor torque, and a motor rotation speed. That is, the motor driving efficiency may be obtained as the ratio of driving torque×rotation speed to voltage×current and the motor regenerative efficiency may be obtained as the ratio of voltage×current to regenerative torque×rotation speed.

The current and voltage for determining the motor driving efficiencies are a current and a voltage that are applied to the motor when the motor is driven. The current and voltage for determining the motor regenerative efficiency are regenerative current and voltage that are generated in motor regeneration operation, and they are motor operation information as well which is transmitted to the central server 200.

Alternatively, the powertrain efficiency may be determined as a function of motor torque and motor rotation speed. To the present end, the controller 130 may have a 2-dimensional table in which powertrain efficiency is set by values according to motor torque and motor rotation speed.

Based on motor torque and motor rotation speed (which may be detection values of sensors such as a resolver) as inputs from the controller 130, powertrain efficiency values corresponding thereto may be determined through interpolation or other methods from the table.

In an exemplary embodiment of the present disclosure, decelerator efficiency is used to determine acceleration energy, as will be described below, and a preset value (e.g., 87%), that is, a value which is determined as a specific constant in accordance with the specifications of the decelerator of a corresponding vehicle may be used as the decelerator efficiency in the controller 130.

An equation that utilizes a drag coefficient and a drag area, as described above, that is

$$\frac{1}{2} ( {C}_{d} \cdot ρ \cdot A \cdot {V}^{2} ) + W \cdot cos θ ( RRC + VRC \cdot V )$$

may be used to determine driving power, but driving power may also be determined using other specific equations.

In detail, the power consumed by driving resistance, that is, driving power may be determined as the product of a diving resistance force F and a vehicle speed V, in which the driving resistance force may be determined as a function of the vehicle speed V instead of determining using vehicle's inherent characteristic values such as the drag coefficient C_{d} and the drag area A.

For example, a driving resistance force may be derived from a quadratic function of a vehicle speed and is expressed as follows.

$$F ( N ) = a \times {V}^{2} + b \times V + c \qquad [ Equation 2 ]$$

where F represents a driving resistance force (N), a represents an air resistance coefficient, b represents a viscous resistance coefficient, c represents a rolling resistance coefficient, and V represents a vehicle speed. The values of a, b, and c may be determined from data measured and collected through preliminary evaluations in a vehicle development phase, and a, b, and c determined in the vehicle development phase may be input and stored in the controller 130 of a production vehicle 100 and then may be used to determine a driving resistance force and driving power from a vehicle speed.

The following Equation 3 represents driving power, and when the driving power is integrated over time, it becomes energy consumed by driving resistance (hereafter, referred to as “driving resistance consumption energy”).

$${P}_{d r i v e} = F \times V = a \times {V}^{3} + b \times {V}^{2} + c \times V \qquad [ Equation 3 ]$$

In Equation 3, P_{drive} represents driving power W, ‘a×V³ is power consumed by air resistance, and b×V²+c×V is power consumed by rolling resistance. The power consumed by rolling resistance may be determined using (b×V²+c×V)×cos θ to apply the gradient information of a driving road as in Equation 1.

Only the driving power may be determined using Equation 3 instead of

$$\frac{1}{2} ( {C}_{d} \cdot ρ \cdot A \cdot {V}^{2} ) + W \cdot cos θ ( RRC + VRC \cdot V )$$

in Equation 1 which is an equation for determining consumed power when a vehicle is driven, and driving energy which is the energy consumed while driving of a vehicle 100 may be determined by integrating the equation for determining consumed power over time (which is a driving time).

A method of determining consumed power and driving energy while driving of a general vehicle was described above. In an exemplary embodiment of the present disclosure, the controller 130 can determine wheel-based acceleration energy using the air resistance consumption energy and rolling resistance consumption energy of driving energy, gradient energy, motor driving energy, and decelerator efficiency, and can determine the final acceleration energy from the determined wheel-based acceleration energy.

The air resistance consumption energy of driving energy may be determined by integrating α×V³ over time, the rolling resistance consumption energy of driving energy may be determined by integrating (b×V²+c×V)×cos θ over time, and the gradient energy may be determined by integrating W×sin θ×V over time.

In an exemplary embodiment of the present disclosure, the motor driving energy may be determined by integrating motor torque×motor rotation speed×vehicle speed over time, in which the motor torque is driving torque which is torque having a positive (+) value and torque of positive (+) direction.

Furthermore, the motor regenerative energy may be determined, which may be calculated by integrating motor torque×motor rotation speed×vehicle speed over time, in which the motor torque is regenerative torque which is torque having a negative (−) value and torque of negative (−) direction.

Furthermore, in an exemplary embodiment of the present disclosure, the controller 130 may be configured to determine wheel-based acceleration energy using, together with motor driving energy and decelerator efficiency, information during operation of an accelerator pedal in which an accelerator pedal is operated by a driver, that is, air resistance consumption energy and rolling resistance consumption energy, which are driving resistance consumption energy during the operation period of an accelerator pedal, and gradient energy in uphill driving.

The controller 130 can determine whether an accelerator pedal is being operated by a driver based on a signal from the accelerator pedal detector, and is configured to determine wheel-based acceleration energy used only to accelerate a vehicle 100 using information which is obtained during operation of the accelerator pedal (while the accelerator pedal is On), that is, motor driving energy, decelerator efficiency, air resistance consumption energy, rolling resistance consumption energy, and gradient energy that are determined during operation of the accelerator pedal.

It is difficult to distinguish energies that are used for acceleration in general vehicles, and acceleration of a vehicle is generated when a driver intentionally utilizes an accelerator pedal, but acceleration or deceleration is generated when driving uphill or downhill regardless of an accelerator pedal. Accordingly, it is not possible to differentiate acceleration energy used to accelerate a vehicle solely based on the rate of acceleration of the vehicle.

Accordingly, to accurately determine acceleration energy used only to accelerate a vehicle regardless of road gradients such as an uphill and a downhill in an exemplary embodiment of the present disclosure, acceleration energy used only to accelerate a vehicle 100 is determined by subtracting the sum of driving resistance consumption energy (the sum of air resistance consumption energy and rolling resistance consumption energy) and gradient energy during operation of an accelerator from motor driving energy.

Driving resistance is always generated while a vehicle 100 moves forward, and accordingly, simply subtracting the sum of driving resistance consumption energy and gradient energy from motor driving energy results in subtraction of excessive energy.

Accordingly, in an exemplary embodiment of the present disclosure, by considering driving resistance consumption energy and gradient energy each separately for the moments when an accelerator pedal is operated and when it is not operated, and by subtracting the sum of the driving resistance consumption energy and gradient energy when the accelerator pedal is operated from motor driving energy, the actual acceleration energy used to accelerate a vehicle is determined.

The acceleration energy determined in the instant way is acceleration energy at the wheels of a vehicle (hereafter, referred to as “wheel-based acceleration energy”) and the final acceleration energy may be determined by converting the acceleration energy into acceleration energy at a motor. The final acceleration energy (battery-based acceleration energy) of the vehicle 100 may be determined as the value obtained by dividing the wheel-based acceleration energy by powertrain efficiency which is the product of decelerator efficiency and motor efficiency.

Meanwhile, the controller 130 of the vehicle is configured to determine driving energy information including air resistance consumption energy, rolling resistance consumption energy, gradient energy, and acceleration energy and transmits the determined driving energy information to the central server 200.

In the case of the air resistance consumption energy and the rolling resistance consumption energy that are diving resistance consumption energy, the controller 130 of the vehicle 100 can differentiate and transmit the values for the accelerator pedal operation period (accelerator pedal is on) and the accelerator pedal non-operation period (accelerator pedal is off) to the central server 200.

The values of the air resistance consumption energy and the rolling resistance consumption energy for the accelerator pedal operation period and the accelerator pedal non-operation period transmitted to the central server 200 are used to determine a maximum possible regenerative braking ratio (%) and an actual regenerative braking ratio (%).

Meanwhile, in the case of the acceleration energy, the value of wheel-based acceleration energy may be transmitted to the central server 200 from the controller 130 of the vehicle 100 and is also used to determine a maximum possible regenerative braking ratio (%) and an actual regenerative braking ratio (%) in the central server 200.

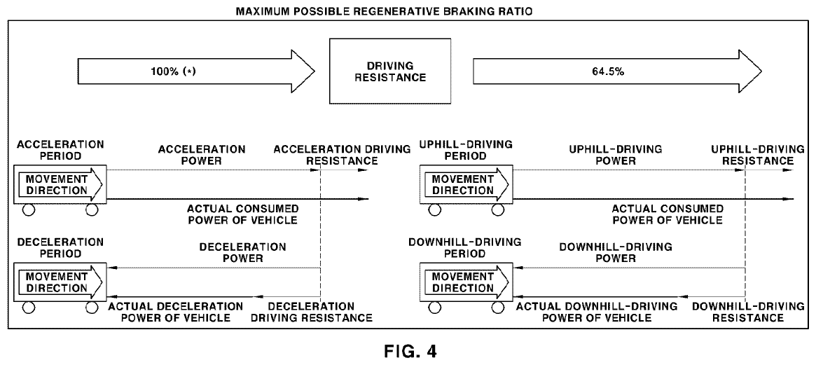

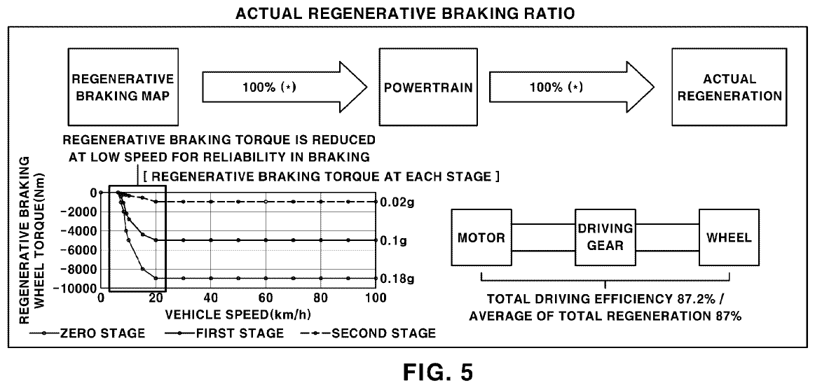

FIG. 4 is a diagram illustrating a method of determining a maximum possible regenerative braking ratio in an exemplary embodiment of the present disclosure and FIG. 5 is a diagram illustrating a method of determining an actual possible regenerative braking ratio in an exemplary embodiment of the present disclosure.

First, FIG. 4 shows an example when a maximum possible regenerative braking ratio is determined as 64.5%. Consumed energy and regenerative energy should be the same in the situation of “stop→acceleration→deceleration→stop” and the situation of “uphill→downhill” of a vehicle under an ideal condition without resistance.

However, in reality, driving resistances such as air resistance and rolling resistance (tire friction resistance) are generated, which means consumption of additional energy in accelerating/uphill driving and some loss of regenerative braking possible energy in decelerating/downhill driving.

In consideration of fact, in an exemplary embodiment of the present disclosure, the central server 200 is configured to determine wheel-based recoverable maximum regenerative braking energy as the value obtained by subtracting driving resistance consumption energy (the sum of air resistance consumption energy and rolling resistance consumption energy) in an accelerator pedal non-operation period from wheel-based acceleration energy and uphill driving energy (i.e., gradient energy in uphill driving), and then use the value to determine a maximum possible regenerative braking ratio (%).

The wheel-based recoverable maximum regenerative braking energy is a maximum recoverable regenerative braking energy considering various resistances and may be determined using the values of motor torque, a motor rotation speed, decelerator efficiency, and driving resistance consumption energy.

This is expressed as the following Equation 4.

$$wheel - based recoverable maximum regenerative braking energy = wheel - based acceleration energy + uphill driving energy ( air resistance consumption energy + rolling resistance consumption energy ) @ accelerator pedal non - \\ operation period = motor torque \times motor rotation speed \times decelerator efficiency ( air resistance consumption energy + rolling resistance consumption energy ) @ entire period \qquad [ Equation 4 ]$$

In Equation 4, “uphill driving energy” is gradient energy in uphill driving of a vehicle and “(air resistance consumption energy+rolling resistance consumption energy)@accelerator pedal non-operation period” represents the sum of air resistance consumption energy and rolling resistance consumption energy during non-operation of the accelerator of a vehicle.

Similarly, “(air resistance consumption energy+rolling resistance consumption energy)@entire period” represents the sum of air resistance consumption energy and rolling resistance consumption energy during the entire driving without distinguishing between the accelerator pedal operation period and the accelerator pedal non-operation period.

Wheel-based recoverable maximum regenerative braking energy may be obtained in the central server 200 based on the driving energy information of a vehicle, as described above, and a maximum possible regenerative braking ratio (%) of the vehicle may be determined, as in the following Equation 5, based on the driving energy information.

$$maximum possible regenerative braking ratio ( \% ) = [ ( wheel - based recoverable maximum regenerative braking energy ) \text{} / \{ wheel - based acceleration energy + uphill driving energy + \\ ( air resistance comsumption energy + rolling resistance consumption energy ) @ accelerator pedal operation period \} ] \times \\ 100 ( \% ) = [ \{ wheel - based acceleration energy + uphill driving energy - ( air resistance consumption energy + rolling resitance consmption energy ) @ accelerator pedal non - operation period \} / \{ wheel - based acceleration energy + uphill driving energy + ( air resistance consumption energy + rolling resistance consumption energy ) @ accelerator pedal operation period \} ] \times 1 \; 00 ( \% ) \qquad [ Equation 5 ]$$

FIG. 5 shows an example in which the actual regenerative braking ratio of specific vehicle and river is determined as 46.9%.

As for the actual regenerative braking ratio, control and powertrain efficiency for braking stability of a vehicle is considered in addition to the effects of the air resistance and rolling resistance considered above, whereby an actual regenerative braking ratio smaller than the maximum possible regenerative braking ratio is determined.

In the central server 200, a determine vehicle-specific (drive-specific) actual regenerative braking ratio may be determined based on driving energy information and motor operation information of each vehicle 100, as in Equation 6. The motor operation information may include, as described above, a regenerative current and a motor voltage that are generated at a motor in regenerative braking of a vehicle 100.

$$actual regenerative braking ratio ( \% ) = \\ [ ( regenerative current \times motor voltage ) / \\ ( wheel - based acceleration energy + uphill driing energy + ( air resistance consumption energy + rolling resistance consumption energy ) @ accelerator pedal operation period \} ] \times 100 ( \% ) \qquad [ Equation 6 ]$$

As a result, a maximum possible regenerative braking ratio (%) and an actual regenerative braking ratio (%) considering the characteristics of each vehicle and the characteristics of a driving route may be determined through the process described above, and it is possible to quantitatively distinguish drivers with appropriate level and insufficient level of use of regenerative braking by comparing the maximum possible regenerative braking ratio and the actual regenerative braking ratio.

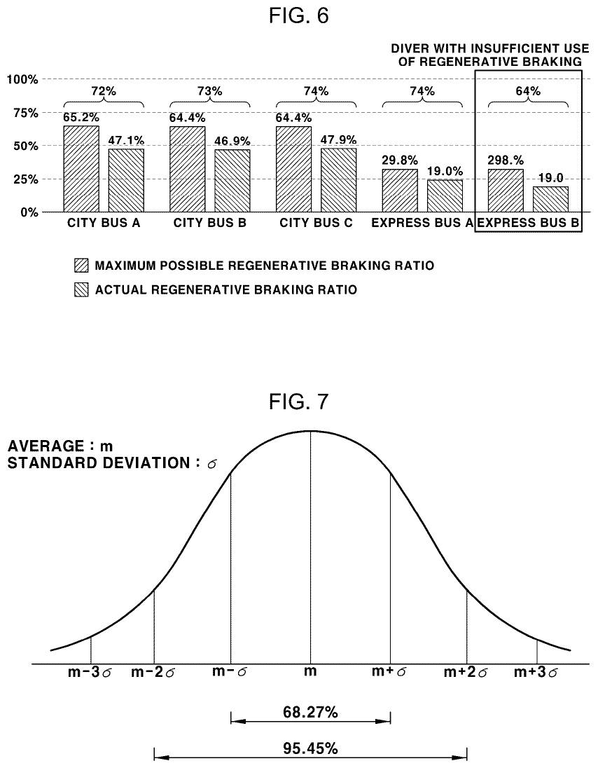

FIG. 6 is a diagram exemplarity showing a maximum possible regenerative braking ratio and an actual regenerative braking ratio of each of vehicles in an exemplary embodiment of the present disclosure, that is, shows a maximum possible regenerative braking ratio and an actual regenerative braking ratio determined for a plurality of vehicles.

Referring to FIG. 6, maximum possible regenerative braking ratios and actual regenerative braking ratios determined for city buses A, B, and C operating on urban routes and express buses A and B operating on intercity routes may be observed.

A city bus may be defined as a bus that primarily operates on urban roads within a city and an express bus may be defined as a bus that primarily operates and travels on highways or intercity roads connecting cities.

As described above, the central server 200 is configured to determine a maximum possible regenerative braking ratio and an actual regenerative braking ratio of each of the vehicles exemplified in FIG. 6 based on driving energy information and motor operation information of each vehicle transmitted from each of the vehicles 100.

The central server 200 divides the actual regenerative braking ratio (%) by the maximum possible regenerative braking ratio (%) for each of the vehicles 100 and can determine how much regenerative braking the drivers use compared to the theoretic maximum possible regenerative braking ratio based on the divided result values.

However, when the level of regenerative braking ratios use are simply compared only based on the actual regenerative braking ratio without using the maximum possible regenerative braking ratio derived based on driving energy of a vehicle, it cannot be comparison reflecting the characteristics of the driving route, which may cause incorrect determination.

For example, in FIG. 6, the actual regenerative braking ratios of the city buses A, B, and C are approximately 47%, whereas the actual regenerative braking ratio of the driver of the express bus A is approximately 24%, which is about half the level of the city bus drivers.

In the instant case, it may be an error to select and determine that the driver of the express bus A is a driver with insufficient use of regenerative braking simply because the actual regenerative braking ratio of the driver is lower than those of the drivers of the city buses A, B, and C.

That is, the driver of the express bus A drives a driving route with a mix of city road and highway modes, such that the regenerative braking usage of the driver is necessarily low in comparison to the city bus drivers who drive only city roads accompanied with continuous acceleration and deceleration.

Accordingly, in consideration of the present aspect in an exemplary embodiment of the present disclosure, a maximum possible regenerative braking ratio is determined using the driving energy of a vehicle, as described above, and in the instant case, it is possible to accurately distinguish drivers with insufficient use of regenerative braking that reflects the characteristics of a vehicle and a driving route even without additional data about the route on which the vehicle has traveled.

When determining the ratio of the actual regenerative braking ratio (%) to the maximum possible regenerative braking ratio (%) for each of the vehicles exemplified in FIG. 6 in percentage, the city bus A is 72%, the city bus B is 73%, and both the city bus C and the express bus A are 74%.

That is, when only the values of the actual regenerative braking ratios are simply compared, the actual regenerative braking ratio of the driver of the express bus A is about half the level of the drivers of the city buses A, B, and C. However, when the drivers are compared based on the values of the ratios of the actual regenerative braking ratio to the maximum possible regenerative braking ratio, the driver of the express bus A utilizes regenerative braking of 74% which is an equal level in comparison to the city bus drivers, so that the driver of the express bus A should also be determined as using regenerative braking sufficiently well.

On the other hand, since the driver of the express bus B utilizes regenerative braking only at the level of 64% in comparison to the maximum possible regenerative braking ratio, the driver of the express bus B may be selected as a driver who uses regenerative braking less than a predetermined amount of use at a low level in comparison to other drivers (see step S14 in FIG. 2).

In an exemplary embodiment of the present disclosure, as a reference for selecting drivers with insufficient use of regenerative braking, it is possible to use the average and standard deviation of the percentage values of the actual regenerative braking ratios to the maximum possible regenerative braking ratios of the drivers.

FIG. 7 is a diagram illustrating a method of selecting drivers with insufficient use of regenerative braking using average and standard deviation in an exemplary embodiment of the present disclosure and exemplifies the average and standard deviation of the values of the percentage values of the actual regenerative braking ratios to the maximum possible regenerative braking ratios of vehicles.

As shown in FIG. 7, the central server 200 selects drivers who used acceleration energy exceeding y sigma based on the average M and the standard deviation σ. In the example shown in FIG. 7, 1 sigma is a lower user level of (100−68.27)/2=15.9%.

The central server 200 selects drivers with insufficient use of regenerative braking, is configured to determine the selected drivers with insufficient use of regenerative braking as drivers who need regenerative braking recommendation, and recommends regenerative braking to the drivers with insufficient use of regenerative braking while guiding them to increase the regenerative braking usage.

In the instant case, the central server 200 transmits a message requesting the vehicles 100 of the drivers with insufficient use of regenerative braking to display a guidance message for increasing use of regenerative braking (see step S15 in FIG. 2). Accordingly, the controller 130 of the vehicles 100 of the drivers with insufficient use of regenerative braking ensures that the guidance message recommending and guiding an increase of use of regenerative braking is displayed through the input/output unit 120 (see steps S16 and S17 in FIG. 2).

Since the drivers use regenerative braking at an insufficient level in comparison to average drivers, as the guidance message, a message reminding the drivers of the disadvantageous aspect of using less regenerative braking in terms of fuel cost reduction and maintenance cost reduction or a message recommending or prompting the drivers to increase regenerative braking usage to the level of the average drivers may be displayed.

A detailed example of the guidance message is provided as follows.

“According to your driving data, it appears that you are using regenerative braking approximately 10% lower than average drivers. Increasing the regenerative braking usage will reduce fuel costs and maintenance costs. Would you like to increase your regenerative braking usage to the level of average drivers?”

Next, when the driver checks the guidance message through the display device of the vehicle 100 and then selects an increase of the use of regenerative braking through the input device, the controller 130 of the vehicle 100 can perform control for increasing the use of regenerative braking usage (see step S19 in FIG. 2). When the driver does not select an increase of the use of regenerative braking, the current level of regenerative braking is maintained (see step S20 in FIG. 2).

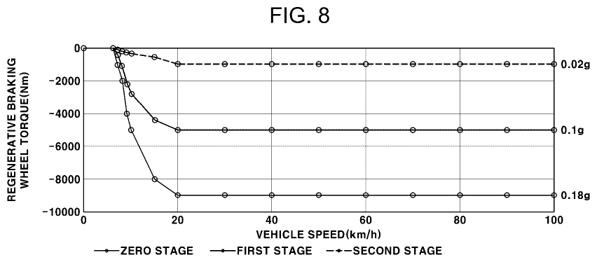

FIG. 8 is a diagram showing an example of a stage-specific regenerative braking map which may be used in a vehicle to which the present disclosure is applied. As shown in the figure, the regenerative braking map of the controller 130, which is a map defining the correlations between a vehicle speed and regenerative braking torque, is a map in which regenerative braking torque (wheel torque) is set based on a vehicle speed.

A plurality of regenerative braking maps may be set by the number of regenerative braking stages, and a plurality of regenerative braking maps set in advance may be input and stored in advance in the controller 130 and may be used by the controller 130 to determine the regenerative braking torque according to a vehicle speed.

In an exemplary embodiment of the present disclosure, control for increasing use of regenerative braking includes a process in which the controller 130 increases the regenerative braking stage of the vehicle 100 to change regenerative braking maps so that the regenerative braking map of the increased stage may be used.

Referring to FIG. 8, the higher the regenerative braking stage, the higher the regenerative braking torque is set at same vehicle speed, so when the regenerative braking stage is increased, use of regenerative braking may be increased.

For example, in the case of a vehicle which is driven on a city road and utilizes the first regenerative braking stage of FIG. 8, the regenerative braking stage may be increased to the second stage. When a vehicle which is driven on an intercity road utilizes the zero stage, the regenerative braking stage may be increased to the first stage to increase the use of regenerative braking.

A torque map of regenerative braking stages of zero state, first stage, and second stage is shown in FIG. 8, but this is an example and the present disclosure is not limited thereto, and the number of regenerative braking stages and the regenerative braking values may be changed in various ways.

The number of regenerative braking stages and the regenerative braking values according to a vehicle speed may be differently set in vehicles and various the regenerative braking pas set for vehicles may be used.

An exemplary embodiment of the present disclosure was described above in detail. According to the system and method for guiding regenerative braking use of a vehicle described above, it is possible to objectively and quantitatively distinguish and determine drivers with insufficient regenerative braking usage based on vehicle's driving data and then encouraging use of regenerative braking for the drivers who are determined to have insufficient generative braking usage.

In an exemplary embodiment of the present disclosure, a driver who needs an increase of regenerative braking is determined by a method of calculating the maximum possible regenerative braking ratio reflecting the characteristics of the driving route of each vehicle, the driving habit and tendency of the driver (e.g., the frequency of acceleration/deceleration) and then comparing the determined maximum possible regenerative braking ratio and the actual regenerative braking ratio.

This considers the fact that the actual regenerative braking ratio changes, depending on the driving routes of vehicles (city road: high regenerative braking ratio, intercity road: low regenerative braking ratio), whereby it is possible to solve the problem of an error when distinguishing drivers with insufficient use of regenerative braking by simply comparing only the regenerative braking ratio that the drivers use.

Furthermore, since the maximum possible regenerative braking ratio which is determined based on driving resistance, acceleration energy, gradient energy, etc. in an exemplary embodiment of the present disclosure, it is possible to reasonably select drivers who need to increase the use of regenerative braking even without data on the driving routes of the vehicles and route classification.

Furthermore, according to the system and method for guiding regenerative braking use of a vehicle of the present disclosure, rather than simply recommending drivers to use regenerative braking more, the system and method of the present disclosure alerts drivers by showing data that quantitatively compares their actual use ratio of regenerative braking with the use level of regenerative braking of average drivers to the drivers with insufficient use of regenerative braking, so it is possible to encourage a more active increase of the use of regenerative braking.

Furthermore, the term related to a control device such as “controller”, “control apparatus”, “control unit”, “control device”, “control module”, “control circuit”, or “server”, etc refers to a hardware device including a memory and a processor configured to execute one or more steps interpreted as an algorithm structure. The memory stores algorithm steps, and the processor executes the algorithm steps to perform one or more processes of a method in accordance with various exemplary embodiments of the present disclosure. The control device according to exemplary embodiments of the present disclosure may be implemented through a nonvolatile memory configured to store algorithms for controlling operation of various components of a vehicle or data about software commands for executing the algorithms, and a processor configured to perform operation to be described above using the data stored in the memory.

The memory and the processor may be individual chips. Alternatively, the memory and the processor may be integrated in a single chip. The processor may be implemented as one or more processors. The processor may include various logic circuits and operation circuits, may be configured for processing data according to a program provided from the memory, and may be configured to generate a control signal according to the processing result.

The control device may be at least one microprocessor operated by a predetermined program which may include a series of commands for carrying out the method included in the aforementioned various exemplary embodiments of the present disclosure.

The aforementioned invention can also be embodied as computer readable codes on a computer readable recording medium. The computer readable recording medium is any data storage device that can store data which may be thereafter read by a computer system and store and execute program instructions which may be thereafter read by a computer system. Examples of the computer readable recording medium include Hard Disk Drive (HDD), solid state disk (SSD), Silicon Disk Drive (SDD), read-only memory (ROM), random-access memory (RAM), CD-ROMs, magnetic tapes, floppy discs, optical data storage devices, etc and implementation as carrier waves (e.g., transmission over the Internet). Examples of the program instruction include machine language code such as those generated by a compiler, as well as high-level language code which may be executed by a computer using an interpreter or the like. Furthermore, the non-transitory computer-readable recording medium may be distributed over computer systems connected through a network, and computer-readable program code may be stored and executed in a distributive manner.

In various exemplary embodiments of the present disclosure, each operation described above may be performed by a control device, and the control device may be configured by multiple control devices, or an integrated single control device.

In various exemplary embodiments of the present disclosure, the memory and the processor may be provided as one chip, or provided as separate chips.

In various exemplary embodiments of the present disclosure, the scope of the present disclosure includes software or machine-executable commands (e.g., an operating system, an application, firmware, a program, etc.) for enabling operations according to the methods of various embodiments to be executed on an apparatus or a computer, a non-transitory computer-readable medium including such software or commands stored thereon and executable on the apparatus or the computer.

In various exemplary embodiments of the present disclosure, the control device may be implemented in a form of hardware or software, or may be implemented in a combination of hardware and software.

Software implementations may include software components (or elements), object-oriented software components, class components, task components, processes, functions, attributes, procedures, subroutines, program code segments, drivers, firmware, microcode, data, database, data structures, tables, arrays, and variables. The software, data, and the like may be stored in memory and executed by a processor. The memory or processor may employ a variety of means well known to a person including ordinary knowledge in the art.

Furthermore, the terms such as “unit”, “module”, etc. included in the specification mean units for processing at least one function or operation, which may be implemented by hardware, software, or a combination thereof.

In the flowchart described with reference to the drawings, the flowchart may be performed by the controller or the processor. The order of operations in the flowchart may be changed, multiple operations may be merged, or any operation may be divided, and a specific operation may not be performed. Furthermore, the operations in the flowchart may be performed sequentially, but not necessarily performed sequentially. For example, the order of the operations may be changed, and at least two operations may be performed in parallel.

Hereinafter, the fact that pieces of hardware are coupled operatively may include the fact that a direct and/or indirect connection between the pieces of hardware is established by wired and/or wirelessly.

In an exemplary embodiment of the present disclosure, the vehicle may be referred to as being based on a concept including various means of transportation. In some cases, the vehicle may be interpreted as being based on a concept including not only various means of land transportation, such as cars, motorcycles, trucks, and buses, that drive on roads but also various means of transportation such as airplanes, drones, ships, etc.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The term “or” used in the present disclosure should be interpreted as indicating “additionally or alternatively.”

The term “and/or” may include a combination of a plurality of related listed items or any of a plurality of related listed items. For example, “A and/or B” includes all three cases such as “A”, “B”, and “A and B”.

In exemplary embodiments of the present disclosure, “at least one of A and B” may refer to “at least one of A or B” or “at least one of combinations of one or more of A and B”. In addition, “one or more of A and B” may refer to “one or more of A or B” or “one or more of combinations of one or more of A and B”.

In the present specification, unless stated otherwise, a singular expression includes a plural expression unless the context clearly indicates otherwise.

The terms used to describe the exemplary embodiments are used for describing specific embodiments, and are not intended to limit the embodiments. As used in the description of the exemplary embodiments and in the claims, the singular forms “a”, “an”, and “the” include plural referents unless the context clearly dictates otherwise. The expression “and/or” is used to include all possible combinations of terms.

In the exemplary embodiment of the present disclosure, it should be understood that a term such as “include” or “have” is directed to designate that the features, numbers, steps, operations, elements, parts, or combinations thereof described in the specification are present, and does not preclude the possibility of addition or presence of one or more other features, numbers, steps, operations, elements, parts, or combinations thereof.

As used herein, conditional expressions such as “if” and “when” are not limited to an optional case and are intended to be interpreted, when a specific condition is satisfied, to perform the related operation or interpret the related definition according to the specific condition.

Terms such as first and second may be used to describe various elements of the embodiments. However, various components according to the exemplary embodiments should not be limited by the above terms. These terms are only used to distinguish one element from another.

According to an exemplary embodiment of the present disclosure, components may be combined with each other to be implemented as one, or some components may be omitted.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described to explain certain principles of the present disclosure and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. A system for guiding regenerative braking use of a vehicle, the system comprising:
a controller configured to transmit driving data through a communication unit operatively connected to the controller in the vehicle;
an input/output unit connected to the controller of the vehicle; and
a central server selecting a driver who uses regenerative braking less than a predetermined amount of use by collecting the driving data transmitted from the controller of the vehicle,
wherein the central server is further configured to determine a maximum possible regenerative braking ratio and an actual regenerative braking ratio of the vehicle based on the collected driving data of the vehicle, to select the driver who uses the regenerative braking less than the predetermined amount of use using the determined maximum possible regenerative braking ratio and the determined actual regenerative braking ratio, and to request the controller in the vehicle of the selected driver to output a message recommending an increase of use of the regenerative braking, and
wherein the controller of the vehicle is configured to control the input/output unit to output the message in accordance with the request for outputting the message received from the central server.

2. The system of claim 1,
wherein the central server collects driving data transmitted from a plurality of vehicles, and
wherein the central server selects drivers who use the regenerative braking less than the predetermined amount of use among drivers of the vehicles using a maximum possible regenerative braking ratio and an actual regenerative braking ratio of each of the vehicles based on the collected driving data of the vehicles.

3. The system of claim 1,
wherein the controller is further configured to select a regenerative braking map with larger regenerative braking torque based on that the driver selects the increase of use of the regenerative braking through the input/output unit with the message output by the input/output unit, and
wherein the controller is configured to control regenerative operation of a motor that drives the vehicle based on the larger regenerative braking torque determined by the selected regenerative braking map.

4. The system of claim 3,
wherein a plurality of regenerative braking maps set for regenerative braking stages, respectively, are stored in the controller, and
wherein the plurality of regenerative braking maps are maps in which regenerative braking torque according to a vehicle speed is set and are maps in which regenerative braking torque is differently set at a same vehicle speed.

5. The system of claim 1, wherein the driving data comprises:
driving energy information of the vehicle which is determined based on information set in the vehicle and information collected while driving; and
operation information of a motor that drives the vehicle.

6. The system of claim 5, wherein the driving energy information of the vehicle comprises gradient energy in uphill driving, acceleration energy, and diving resistance consumption energy in each of an accelerator pedal operation period and an accelerator pedal non-operation period that are determined by equations based on the set information and the information collected while driving.

7. The system of claim 6, wherein the central server is further configured to:
determine wheel-based acceleration energy using the diving resistance consumption energy in the accelerator pedal operation period and the gradient energy in the uphill driving,
determine wheel-based recoverable maximum regenerative braking energy from the wheel-based acceleration energy and the diving resistance consumption energy in the accelerator pedal non-operation period, and
determine the maximum possible regenerative braking ratio using the determined wheel-based recoverable maximum regenerative braking energy.

8. The system of claim 7, wherein the central server is further configured to determine the wheel-based recoverable maximum regenerative braking energy as a value obtained by subtracting the diving resistance consumption energy in the accelerator pedal non-operation period from a sum of the wheel-based acceleration energy and the gradient energy in the uphill driving.

9. The system of claim 7, wherein the central server is further configured to determine the maximum possible regenerative braking ratio as a ratio value obtained by dividing the wheel-based recoverable maximum regenerative braking energy by a sum of the wheel-based acceleration energy, the gradient energy in the uphill driving, and the diving resistance consumption energy in the accelerator pedal operation period.

10. The system of claim 6, wherein the central server is further configured to:
determine wheel-based acceleration energy using the diving resistance consumption energy in the accelerator pedal operation period and the gradient energy in the uphill driving, and
determine the actual regenerative braking ratio from a regenerative current which is generated in the regenerative braking, a motor voltage in the regenerative braking, the wheel-based acceleration energy, the gradient energy in the uphill driving, the diving resistance consumption energy in the accelerator pedal operation period as the operation information of the motor.

11. The system of claim 10, wherein the central server is further configured to determine the actual regenerative braking ratio as a ratio value obtained by dividing a product of the regenerative current and the motor voltage by a sum of the wheel-based acceleration energy, the gradient energy in the uphill driving, and the diving resistance consumption energy in the accelerator pedal operation period.

12. The system of claim 1, wherein the central server is further configured to select the driver who uses the regenerative braking less than the predetermined amount of use using a value obtained by dividing the maximum possible regenerative braking ratio of the vehicle by the actual regenerative braking ratio.

13. The system of claim 12, wherein the central server is further configured to:
determine a maximum possible regenerative braking ratio and an actual regenerative braking ratio of each of vehicles based on driving data collected for the vehicles, and
select a driver who uses regenerative braking less than a predetermined amount of use using information of average and standard deviation of a percentage value of the actual regenerative braking ratio of each of the vehicles to the maximum possible regenerative braking ratio of each of the vehicles.

14. A method of guiding regenerative braking use of a vehicle, the method comprising:
collecting, by a central server, driving data which is transmitted from a vehicle;
determining, by the central server, a maximum possible regenerative braking ratio and an actual regenerative braking ratio of the vehicle based on the collected traveling data of the vehicle;
selecting, by the central server, a driver who uses regenerative braking less than a predetermined amount of use using the determined maximum possible regenerative braking ratio and the determined actual regenerative braking ratio;
requesting, by the central server, a controller in the vehicle of the selected driver to output a message recommending an increase of use of the regenerative braking; and
controlling, by the controller, an input/output unit connected to the controller to output the message in accordance with the request for outputting the message received from the central server in the vehicle of the selected driver.

15. The method of claim 14, wherein the controller is configured to:
select a regenerative braking map with larger regenerative braking torque based on that the driver selects the increase of use of the regenerative braking through the input/output unit with the message output by the input/output unit, and
control regenerative operation of a motor that drives the vehicle based on the larger regenerative braking torque determined by the selected regenerative braking map.

16. The method of claim 14, wherein the driving data comprises:
driving energy information of the vehicle which is determined based on information set in the vehicle and information collected while driving; and
operation information of a motor that drives the vehicle.

17. The method of claim 16, wherein the driving energy information of the vehicle comprises gradient energy in uphill driving, acceleration energy, and diving resistance consumption energy in each of an accelerator pedal operation period and an accelerator pedal non-operation period that are determined by equations based on the set information and the information collected while driving.

18. The method of claim 17, wherein the determining of the maximum possible regenerative braking ratio of the vehicle comprises:
determining wheel-based acceleration energy using the diving resistance consumption energy in the accelerator pedal operation period and the gradient energy in the uphill driving;
determining wheel-based recoverable maximum regenerative braking energy from the wheel-based acceleration energy and the diving resistance consumption energy in the accelerator pedal non-operation period; and
determining the maximum possible regenerative braking ratio using the determined wheel-based recoverable maximum regenerative braking energy.

19. The method of claim 17, wherein the determining of the actual regenerative braking ratio comprises:
determining wheel-based acceleration energy using the diving resistance consumption energy in the accelerator pedal operation period and the gradient energy in the uphill driving; and
determining the actual regenerative braking ratio from a regenerative current which is generated in the regenerative braking, a motor voltage in the regenerative braking, the wheel-based acceleration energy, the gradient energy in the uphill driving, the diving resistance consumption energy in the accelerator pedal operation period as the operation information of the motor.

20. The method of claim 14, wherein the selecting of the driver who uses the regenerative braking less than the predetermined amount of use comprises selecting the driver who uses the regenerative braking less than the predetermined amount of use using a value obtained by dividing the maximum possible regenerative braking ratio of the vehicle by the actual regenerative braking ratio.
